(19) United States
(12) Patent Application Publication
(10) Pub. No.: US 2003/0164675 A1
(43) Pub. Date: Sep. 4, 2003

(54) Image-forming apparatus subjected to antistatic treatment

(75) Inventor: Yoichi Ando, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 10/370,533

(22) Filed: Feb. 24, 2003

(30) Foreign Application Priority Data
Mar. 1, 2002 (JP) 056199/2002
Feb. 14, 2003 (JP) 036541/2003

(51) Int. Cl. H01J 1/62

(52) U.S. Cl. 313/495; 345/55

(57) ABSTRACT

An image-forming apparatus, which consumes low electrical power and prevents discharge owing to the surfaces exposed onto the inside of a vacuum container at the time of image display, and can obtain a good image having high brightness, is disclosed. The image-forming apparatus comprises a rear plate provided with an electron source for emitting an electron, and a face plate provided with an image-forming member having an anode electrode, to which electric potential higher than the highest voltage to be applied to the electron source is applied, and a member for forming an image by being irradiated with electrons emitted from the electron source. And, a vacuum container is formed by arranging the rear plate and the face plate to be opposed to each other. At least a part of the surfaces exposed into the inside and the outside of the area in which the image-forming member is formed among the surfaces exposed into the vacuum container is covered with a high resistance film, and a sheet resistance value of one part of the high resistance film which is situated on the inside of the area where the image-forming member is formed is lower than that of another part of the high resistance film which is situated on the outside of the area where the image-forming member is formed.

### BACKGROUND OF THE INVENTION

1. Field of the Invention

The present invention relates to an image-forming apparatus using an electron source.

2. DESCRIPTION OF THE RELATED ART

Two kinds of electron-emitting devices of a hot cathode device and-a cold cathode device have hitherto been known as an electron-emitting device. As the cold cathode device between them, for example, a surface conduction electron-emitting device, a field emission type (hereinafter referred to as FE type) device, a metal/insulating layer/metal type (hereinafter referred to as MIM type) electron-emitting device, and the like are known.

As the surface conduction electron-emitting device, for example, one disclosed in M. I. Elinson, Radio Eng. Electron Phys., 10, 1290, (1965), and other examples which will be described later are known.

The surface conduction electron-emitting device includes a thin film which is formed on a substrate and has a small area. When an electric current flows through the thin film in parallel to a surface of the thin film, electrons are emitted from the thin film. The surface conduction electron-emitting device utilizes this phenomenon. As the surface conduction electron-emitting device, the following ones have been reported in addition to the ones using a SnO₂ thin film by the aforesaid Elinson and others. They are one using an Au thin film (G. Dittmer, “Thin Solid Films”, 9, 317 (1972)), one using a thin film of In₂O₃/SnO₂ (M. Hartwell and C. G. Fonstad, IEEE Trans. ED Conf., 519 (1975)), one using a carbon thin film (H. Araki et al., Vacuum, Vol. 26, No. 1, 22 (1983)), and the like.

Because the above-mentioned cold cathode device can achieve an electron emission at a lower temperature in comparison with the hot cathode device, the cold cathode device does not need a heater for heating the device. Hence, the structure of the cold cathode device is simpler than that of the hot cathode device, and consequently fine cold cathode devices can also be produced. Moreover, even if many cold cathode devices are arranged on a substrate at a high density, problems of the hot melt of the substrate and the like are difficult to produce. Furthermore, the cold cathode device has also the advantage that the response speed thereof is high differently from the hot cathode device having a low response speed because the hot cathode device operates by being heated by a heater.

Accordingly, researches for applying the cold cathode device have been made energetically.

For example, because the surface conduction electron-emitting device has especially simple structure among the cold cathode devices and also is easy to manufacture, the surface conduction electron-emitting device has the advantage that many devices can be formed over a large area. Accordingly, methods for arranging many devices to drive them have been researched as disclosed in, for example, Japanese Patent Application Laid-Open Gazette No. 64-31332 by the assignee of the present invention.

In addition, for example, an image-forming apparatus such as an image display, an image-recording apparatus and the like, a source of a charged beam and the like have been researched as the uses of the surface conduction electron-emitting device.

In particular, an image display using the surface conduction electron-emitting device and a phosphor emitting light by collisions of electrons in combination, as disclosed in U.S. Pat. No. 5,066,883 by the assignee of the present invention, Japanese Patent Application Laid-Open Gazette No. 2-257551 and Japanese Patent Application Laid-Open Gazette No. 4-28137, has been researched as the application of the surface conduction electron-emitting device to the image display. The image display using the surface conduction electron-emitting device and the phosphor in combination is expected to have characteristics superior to those of conventional other type image displays. For example, the image display using the surface conduction electron-emitting device and the phosphor is superior to a liquid-crystal display, which has recently become popular, in the fact that the image display using the surface conduction electron-emitting device and the phosphor does not need a back-light because it emits light by itself, and in the fact that the image display using the surface conduction electron-emitting device and the phosphor has a wide view angle.

Moreover, a method for driving many arranged FE type devices is disclosed in U.S. Pat. No. 4,904,895 by the assignee of the present invention. Furthermore, a flat panel display reported by R. Mayer et al. (R. Mayer, “Recent Development on Microchips Display at LETI”, Tech. Digest of 4^{th} Int. Vacuum Microelectronics Conf., Nagahama, pp. 6-9 (1991)) is known as an example of the application of the FE type device to an image display.

Moreover, an example of the application of many arranged MIM type devices to an image display is disclosed in, for example, Japanese Patent Application Laid-Open Gazette No. 3-55738 by the assignee of the present invention.

Because the plane type display having a shallow depth among the image display using electron-emitting devices described above can save space and is light in weight, the plane type display attracts attention as one to replace a cathode-ray type display.

A high voltage (Va) ranging from hundreds of volts to ten-odd kilovolts is applied between the electron source and the image-forming member of any of the plane type display panels, and the electrons which have been emitted from the electron source and have been accelerated collide with the image-forming member. Thus, the display panel emits light.

Consequently, for example, a part of electron beams input into the image-forming member is scattered to collide with the inner wall of a vacuum container in some case. The collided beam makes the inner wall radiate secondary electrons, and charges up the part to raise the electric potential at the part. Thereby, the electric potential distribution in the vacuum container is distorted to make the trajectories of the electron beams unstable, and further to generate discharges in the vacuum container. Hence, the display panel has the problem of the danger of the deterioration or the destruction of the panel owing to the discharges.

That is, since the electric potential at the charged-up part becomes high, the part attracts electrons. Consequently, the charge-up further advances to generate discharges along the inner wall of the vacuum container.

A method for removing the charges generated in the way described above by forming an antistatic film having an appropriate impedance on the inner wall of the vacuum container can be applied as a method for preventing the charge-up of the inner wall of the vacuum container which charge-up becomes a cause of such a discharge. As an example of the application of such a method, the configuration in which an electrically conductive layer made of a high impedance electrically conductive material is provided on the side surface of the inner wall of a glass container of an image-forming apparatus is disclosed in Japanese Patent Application Laid-Open Gazette No. 10-321167 (EP 865069A). Moreover, in EP 1117124A also, the configuration in which an antistatic film is formed on the inner wall of a vacuum container is disclosed.

Furthermore, as a flat panel display becomes larger in size, there is the case where spacers are provided in the vacuum container as structures for withstanding atmospheric pressure. The surfaces of the spacers also have the same problem as that of the above-described inner wall of the vacuum container.

An example in which antistatic films are applied to the surfaces and the side walls of the spacers, and further an example an antistatic film is also formed on a supporting frame constituting the vacuum container are disclosed in Japanese Patent Application Laid-Open Gazette No. 8-180821 (EP 690472A).

In addition, there is actually the case in which the above-mentioned high voltage (Va) is also applied to parts other than the image-forming section, for example, a high voltage output terminal.

However, the above-described display panel has the following problems.

As described above, the high voltage (Va) is applied the area between the electron source and the image-forming member. Then, for coping with charge and discharge accompanying the charge, the peripheral parts of the high voltage application part are covered by high resistance films such as antistatic films or the like, which increases the electrical power consumption of the display. For suppressing the increase of the electrical power consumption and for realizing the antistatic function, the resistance values of the antistatic films are considered. However, because various conditions such as the operating conditions of the display, positions at which the antistatic films are formed in the display, and the like are complicated, it was difficult to design the resistance values of the antistatic films to be optimum values.

### SUMMARY OF THE INVENTION

Accordingly, it is the objective of the present invention to provide an image display having the following technical advantages. That is, the image display consumes low electric power, can prevent discharge originating in an exposed surface existing on the inner face of a vacuum container at the time of image display, has high brightness, and can obtain a good displayed image.

To achieve the above objective, the image-forming apparatus according to the present invention comprises the following components:

a rear plate provided with an electron source for emitting electrons;

a face plate provided with an image-forming member having an anode electrode, to which electric potential higher than the highest potential to be applied to said electron source is applied, and a member for forming an image by being irradiated with electrons emitted from said electron source;

a vacuum container formed by arranging said rear plate and said face plate to be opposed to each other;

a first high resistance film formed on at least a part of a first surface among surfaces exposed into said vacuum container, said first surface being situated on an inside of an area in which said image-forming member is formed; and

a second high resistance film formed at least a part of a second surface among said surfaces exposed into said vacuum container, said second surface being situated on an outside of the area in which said image-forming member is formed,

And, this image-forming apparatus is unique in the respect that at least a part of said second high resistance film has a sheet resistance value higher than that of said first high resistance film.

According to the present invention, the resistance values of the high resistance films on the inside and on the outside of the area where the image-forming member is formed are made to differ from each other in consideration of the difference of charge quantities owing to reflection electrons of electron beams from the face plate. That is, the charge quantity of the high resistance film arranged on the outside of the formation area of the image-forming member (the area in which the image-forming member is formed and the orthogonal projection area of the former area onto the rear plate), which side is comparatively distant from electron beam trajectories, is less than the charge quantity of the high resistance film arranged near by the electron beam trajectories on the inside of the formation area of the image-forming member, which side is exposed to reflection electrons and the like causing charge at a relatively high density. That is, it is necessary to make an electric current easy to flow through the parts, located on the inside of the formation region of the image-forming member, of the high resistance films by making the sheet resistance values of the parts smaller than the sheet resistance values of the parts located on the outside of the formation area of the image-forming member. However, it is not necessary to make the resistance values on the outside of the image-forming member formation region, where electrons are not dispersed so much, small to the degree of the resistance values on the inside of the image-forming member formation region. Thereby, the prevention effect of the charge owing to dispersed electrons can be obtained. In addition to this, the generation of discharge is suppressed, and electric power consumption of the display can be suppressed. Furthermore, it becomes possible to stabilize the trajectories of electron beams. Incidentally, the reason why the fiducial point (boundary point) of the difference of the resistance values of the high resistance films is set at the image-forming member formation region is that the image-forming member formation area is the area in which charge is easiest to generate (electron flying area) because almost all of the emission electrons from the electron-emitting devices and the electrons produced newly by the irradiation of the emission electrons from the electron-emitting devices (for example, electrons of the reflection electrons from the face plate, the secondary electrons from the surfaces of the spacers, and the like) fly toward the image-forming member, to which the high voltage is applied.

Moreover, the image-forming apparatus may have the configuration in which a surface to which an electric field of at least 2 kV/mm or more is applied among the surfaces exposed into the vacuum container is covered by a high resistance film.

Moreover, another image-forming apparatus according to the present invention comprises the following components:

a rear plate provided with an electron source for emitting electrons;

a face plate provided with an imaging-forming member having an anode electrode, to which electric potential higher than the highest potential to be applied to said electron source is applied, and a member for forming an image by being irradiated with electrons emitted from said electron source;

a vacuum container formed by arranging said rear plate and said face plate to be opposed to each other;

a spacer abutting on said image-forming member and said electron source to hold a space between said face plate and said rear plate;

an anode wiring electrode for feeding said anode electrode;

guard electrodes disposed around at least one of said anode electrode and said anode wiring electrode, said guard electrodes being regulated to electric potential lower than electric potential to be applied to said anode electrode, said spacer, said anode wiring electrode and said guard electrodes being placed in said vacuum container;

a first high resistance film which is formed on a surface of said spacer and electrically connected to said anode electrode and said electron source; and

a second high resistance film which is formed on an inner face of said vacuum container between at least either one of said anode electrode and said anode wiring electrode and said guard electrodes and electrically connected to said at least either one of said anode electrode and said anode wiring electrode and said guard electrodes.

And, this image-forming apparatus is unique in the respect that at least a part of said second high resistance film has a sheet resistance value higher than that of said first high resistance film.

As described above, the surfaces of the spacers, and the area between at least of the anode electrode and the anode wiring electrode and the guard electrode are covered by the high resistance films for antistatic treatment, and the resistance values of the high resistance films on the surfaces of the spacers adjacent to the flying paths of electrons and the resistance value of the high resistance film between at least either of the anode electrode and the anode wiring electrode and the guard electrode comparatively distant from the flying paths of the electrons differ from each other. Thereby, the electric power consumption of the display can be suppressed while charge can effectively be prevented. In particular, the parts where high electric fields are applied, in concrete terms, the surfaces to which the electric fields of 2 kV/mm or more are applied, among the parts in the vacuum inner face to which electric fields are applied are covered by the antistatic films, and consequently the generation of discharge can especially effectively be escaped.

Moreover, the image-forming apparatus may have the configuration in which the guard electrode is formed on an inner face of the face plate.

Moreover, the image-forming apparatus may have the configuration in which the anode wiring electrode includes a part touching an inner face of the rear plate, and in which at least one of the guard electrodes is formed on the inner face of the rear plate.

Moreover, the image-forming apparatus may have the configuration in which the electron source includes a plurality of electron-emitting devices connected to wiring.

Moreover, the image-forming apparatus may have the configuration in which a plurality of electron-emitting devices is wired in a matrix composed of a plurality of pieces of row-directional wiring and a plurality of pieces of column-directional wiring. Thereby, it becomes possible to emit electrons from a desired device selectively, and to form an image by irradiating the image-forming member with the emitted electrons.

Moreover, the image-forming apparatus may have the configuration in which the electron emitting devices are cold cathode devices, preferably surface conduction electron-emitting devices.

### BRIEF DESCRIPTION OF THE DRAWINGS

FIG. 1 is a plan view showing an example of the configuration of the image-forming apparatus of a first embodiment according to the present invention typically;

FIGS. 2A, 2B and 2C are type views showing the configurations of the cross sections along the A-A′ line, the B-B′ line and the C-C′ line in FIG. 1;

FIGS. 3A and 3B are type views showing an example of the configuration of a simple of a surface conduction electron-emitting device according to the present invention;

FIGS. 4A and 4B are views showing waveforms of pulse voltages to be used at the time of the formation of the electron-emitting region of the surface conduction electron-emitting device according to the present invention;

FIG. 5 is a view showing electrical characteristics of the surface conduction electron-emitting device according to the present invention;

FIGS. 6A and 6B are type views showing fluorescent films according to the present invention;

FIGS. 7A, 7B, 7C, 7D and 7E are views showing parts of the manufacturing process of an image display according to the present invention;

FIG. 8 is a plan view showing an example of the configuration of the image-forming apparatus of a second embodiment according to the present invention typically;

FIGS. 9A, 9B and 9C are type views showing the configurations of the cross sections along the A-A′ line, the B-B′ line and the C-C′ line in FIG. 8;

FIG. 10 is a plan view showing an example of the configuration of the image-forming apparatus of a third embodiment according to the present invention typically; and

Figs. 11A, 11B and 11C are type views showing the configurations of the cross sections along the A-A′ line, the B-B′ line and the C-C′ line in FIG. 10.

### DETAILED DESCRIPTION OF THE PREFERRED EMBODIMENTS

Next, the preferred embodiments of the present invention will be described by reference to the attached drawings.

(First Embodiment)

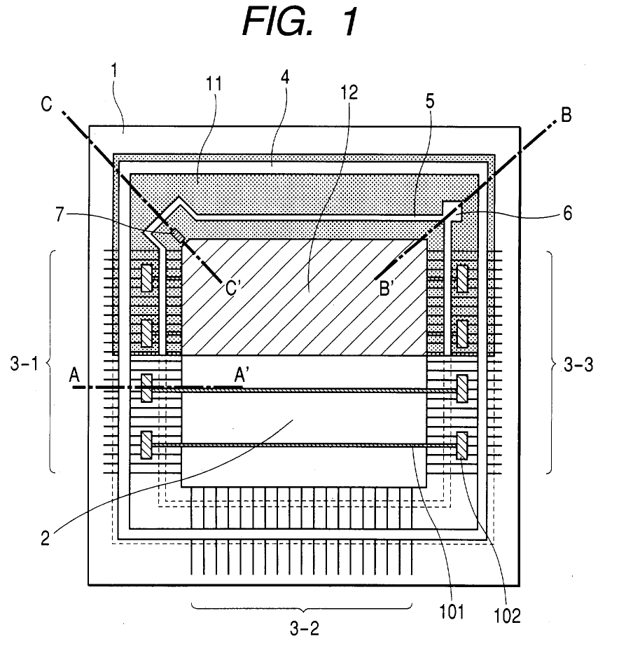

FIG. 1 is a plan view showing the configuration of the image-forming apparatus of the present embodiment. FIG. 1 shows the configuration when it is viewed from a position above a face plate. Incidentally, FIG. 1 is a view showing the configuration in which the lower half surface of the face plate is removed for convenience's sake.

In FIG. 1, a rear plate 1 is also used as a substrate for forming an electron source 2. The rear plate 1 is made of various materials according to conditions. The materials are soda lime glass, soda lime glass having a SiO₂ coating sheet on a surface, glass containing less Na, silica glass, a ceramic, and the like. Incidentally, the substrate for forming the electron source 2 may be formed separately from the rear plate 1, and the substrate and the rear plate 1 may be jointed to each other after the formation of the electron source 2.

The electron source 2 is formed by arranging a plurality of electron-emitting devices such as the surface conduction electron-emitting devices and the like, and by forming wiring connected to the devices in order to drive the devices according to an object.

Moreover, in a vacuum container composed of the rear plate 1 and the face plate 11, both being arranged to be opposed to each other, a getter (not shown) is disposed for maintaining the degree of vacuum therein besides them.

Wiring 3-1, 3-2 and 3-3 for driving the electron source 2 is drawn out of the image-forming apparatus to be connected to a driving circuit (not shown) of the electron source 2. A supporting frame 4 is held between the rear plate 1 and the face plate 11, and is connected to the rear plate 1 with frit glass (not shown). The wiring 3-1, 3-2 and 3-3 for driving the electron source 2 is drawn out to the outside from joining parts of the supporting frame 4 with the rear plate 1 with being buried in the frit glass. An insulating layer (not shown) is formed between the wiring 3-1, 3-2 and 3-3 for driving the electron source 2, and the frame 4.

Spacers 101 become necessary as the image-forming apparatus becomes larger in size, or as the member of the face plate 11 and the member of the rear plate 1 become thinner in thickness.

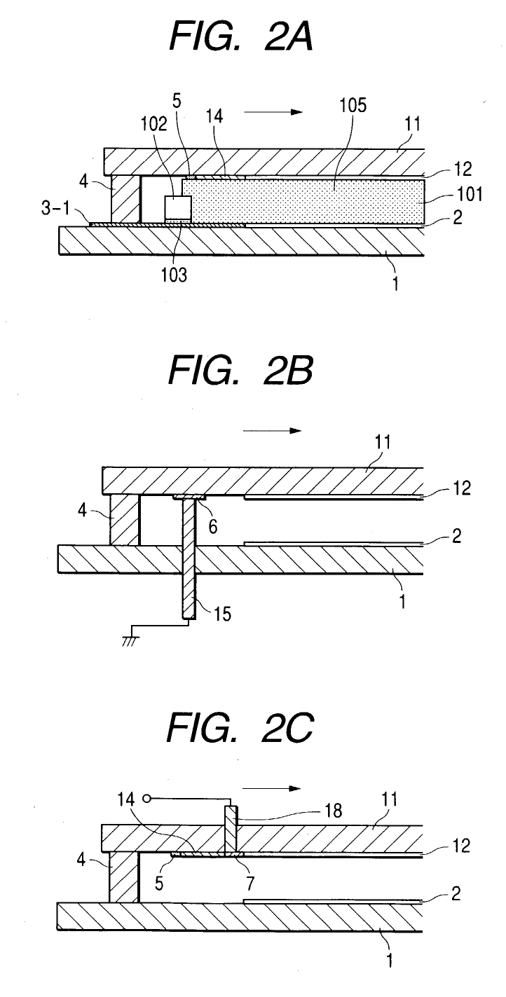

Moreover, the spacers 101 in the present embodiment are made of thin plate glass. High resistance films A (first high resistance films) 105 shown in FIG. 2A are previously formed on the surfaces of the spacers 101 for antistatic treatment. The spacers 101 are then adhered to spacer-supporting bodies 102 made of alumina with an inorganic adhesive. After that, the spacers 101 are joined with the real plate 1, the face plate 11 and the like with frit glass. In the present embodiment, the high resistance films A 105 in FIG. 2 were formed by means of the spray coating method of fine particles of graphite. However, the method is not limited to the spray coating method. Various film-forming methods such as the sputtering method, the dipping method and the like can be used. Incidentally, in the following descriptions, a high resistance film is sometimes called as an antistatic film, but both of them indicate the same one.

A guard electrode 5 is made of a low resistance conductor, and is formed to surround a phosphor area on the inner face of the face palate 11. Moreover, the spacer-supporting bodies 102 are arranged on the outside of the guard electrode 5.

FIGS. 2A, 2B and 2C are type views showing the configurations of the cross sections along the A-A′ line, the B-B′ line and the C-C′ line in FIG. 1.

In FIG. 2A, an image-forming member 12 is composed of a fluorescent film and an anode electrode of a metal film such as Al or the like, which is called as a black stripe (or a black matrix) and metal backing. The high resistance films A 105 being the antistatic films are formed on the spacers 101 in an image-forming member formation area. In addition, the spacer-supporting members 102, the frit glass 103 and the drawing-out wiring 3-1 are formed on the rear plate 1. Furthermore, a high resistance film B (a second high resistance film) 14 is provided on the face plate 11 on the outside of the image-forming member 12 (the outer periphery of the image-forming member 12 is equal to the outer periphery of the anode electrode because the anode electrode is arranged on the outside of the phosphor and the black stripe in the present embodiment). Then, the high resistance film B 14 is formed on the inner wall of the vacuum container between the guard electrode 5 and the image-forming member 12. Moreover, the distance between the guard electrode 5 and the image-forming member 12 is set to be 4 mm in the present embodiment.

In addition, when an image is displayed, the electric potential of the guard electrode 5 is regulated to 0 V being the electric potential of the electron source 2, and the voltage of 10 kV, which is the accelerating potential of the image-forming apparatus, is applied to the image-forming member 12.

Moreover, the quality of the materials of the high resistance films A 105 and the high resistance film B 14 is not especially limited as long as the materials can have prescribed sheet resistance values and sufficient stability. For example, the film in which the fine particles of graphite are dispersed at an appropriate density can be used. Because the high resistance films A 105 and the high resistance film B 14 do not achieve their effects when their sheet resistance values are too large, it is necessary that they have a certain measure of electrical conductivity. However, if the resistance values are too small, their electrical power consumption increases. Accordingly, it is necessary to increase their resistance values within a range in which their effects are not damaged. Although the sheet resistance values depend on the shape of the image-forming apparatus, the sheet resistance values of the high resistance film A 105 are preferably within a range from 10⁷ Ω/□ to 10¹⁴ Ω/□. And, the sheet resistance value of the high resistance film B 14 is preferably within a range from 10¹⁰ Ω/□ to 10¹⁶ Ω/□. That is, in the present invention,“high resistance” means a resistance within a range from 10⁷ Ω/□ to 10¹⁶ Ω/□. With regard to the sheet resistance values of these high resistance films, it gradually becomes clear from results of experiments that the sheet resistance value of the high resistance film B 14 can be made larger than those of the high resistance films A 105. That is, regarding the upper limit value of the sheet resistances for obtaining the same antistatic effect, it is ascertained that the relationship, (the upper limit value of the high resistance films A 105)<(the upper limit value of the high resistance film B 14), is always satisfied.

The relationship is explained on the basis of the difference of the charge quantities in each film owing to reflection electrons of electron beams from the face plate 11. That is, the high resistance film B 14 arranged on the outside of the image area comparatively distant from the trajectories of electron beams has less charges in comparison with the high resistance films A 105 arranged near by the trajectories of the electron beams to be exposed to the reflection electrons and the like which cause charging at a relatively high density. That is, a relationship concerning the largeness of the sheet resistance values is set. In the relationship, the sheet resistance values of the high resistance films A (the first high resistance films) 105 are made to be smaller than that of the high resistance film B (the second high resistance film) 14. The high resistance films A 105 are formed on the surfaces of the spacers 101 being the exposed surfaces existing in the area in which image-forming member 12 is provided and the image-forming member formation area being the orthogonal projection area of the former area onto the rear plate 1, namely the area in which the image-forming member 12 is provided and the orthogonal projection area of the former area onto the rear plate 1, among the exposed surfaces abutting on both of the electrodes on which high electrical potential is applied and the electrodes regulated by other electrical potential such as the electric potential at the ground. The high resistance film B 14 is formed on the exposed surface on the outside of the image-forming member formation area among the above-mentioned exposed surfaces. Thereby, the electrical power consumption of the display is suppressed while the trajectories of the electron beams can be made to be stable and the generation of discharge can be suppressed. Incidentally, in the present embodiment, the sheet resistance values of the high resistance films A 105 were set to be 10¹² Ω/□, and the sheet resistance value of the high resistance film B 14 was set to be 10¹⁵ 106 /□. That is, it is necessary to make the sheet resistance values at the parts located on the inside of the image-forming member 12, where electrons are dispersed, be low to some degree to make charges easy to escape among the high resistance films A 105 and B 14. On the contrary, it is not necessary to make the sheet resistance value of the area on the outside of the image area, where electrons are not dispersed so much, be low. Thereby, the antistatic effect to the dispersed electrons can be obtained. In addition, the generation of discharge can be suppressed and the electric power consumption of the display can be suppressed while the trajectories of the electron beams can be stabilized.

As described above, the wall surfaces of the spacers 101 and the periphery of the image-forming member 12 are covered with high resistance films among the surfaces exposed on the inside of the display. In particular, it is desirable to cover at least the surfaces to which electric fields of at least 2 kV/mm or more are applied with high resistance films.

Although the tabular spacers 101 having a length longer than that of the image area are used in the present embodiment, the shapes of the spacers 101 are not limited to the shape. For example, the shapes may be tabular one having a length shorter than that of the image area, or the shapes may be columnar. In case of a spacer having a length longer than that of the image-forming member formation area, it is also possible to make the resistance values of the high resistance films different on the inside and on the outside as described above. That is, it is also possible to make them different so that the sheet resistance value on the inner side of the image-forming member formation area is lower than that on the outside of the area. In this case, further reduction of the electric power consumption of the display can be achieved.

In FIG. 2B, a ground connecting terminal 15 is connected to an abutting part 6 of the guard electrode 5. The ground connecting terminal 15 is a bar made of a metal such as Ag, Cu or the like. Incidentally, the configuration may be one to draw out the ground connecting terminal 15 onto the face plate side.

In FIG. 2C, an anode wiring electrode 18 being a terminal for introducing a high voltage is connected to a high voltage abutting part 7 of the image-forming member 12. The anode wiring electrode 18 is a bar made of a metal such as Ag, Cu or the like.

Incidentally, the kinds of the electron-emitting devices constituting the electron source 2 used in the present embodiment are not especially limited as long as they have properties such as electron emission characteristics, device sizes and the like suitable for an aimed image-forming apparatus. For example, such cold cathode devices and the like can be used as a thermionic emission device, a field emission device, a semiconductor electron-emitting device, an MIM type electron-emitting device, a surface conduction electron-emitting device, and the like.

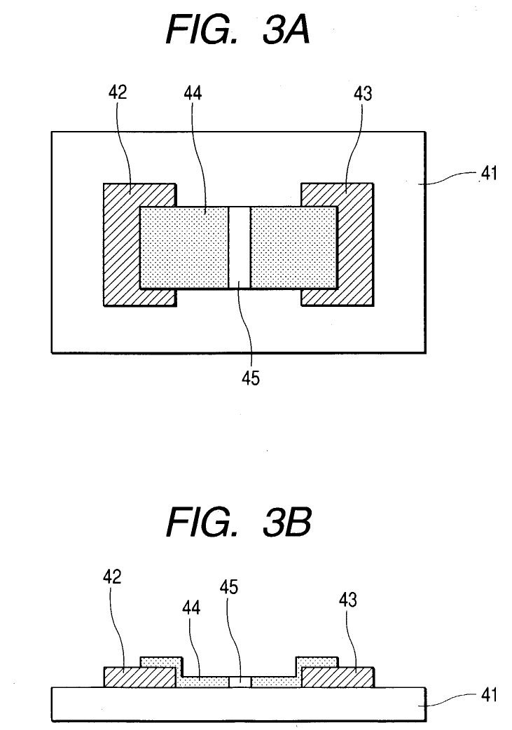

The surface conduction electron-emitting device, which will be described later, is preferably used in the present embodiment. In the following, the device will be simply described. FIGS. 3A and 3B are type views showing an example of the configuration of a simple of a surface conduction electron-emitting device. FIG. 3A is a plan view, and FIG. 3B is a sectional view.

In FIGS. 3A and 3B, a reference numeral 41 designates a substrate for forming an electron-emitting device thereon; reference numerals 42 and 43 designates a pair of device electrodes; and a reference numeral 44 designates an electroconductive film connected to the device electrodes 42 and 43. In a part of the electroconductive film 44, an electron-emitting region 45 is formed. The electron-emitting region 45 is the part of the electroconductive film 44 which part is destroyed, deformed or changed in quality to be highly resistant by the forming operation, which will be described later. A fissure is formed in a part of the electroconductive film 44, and electrons are emitted from the neighborhood of the fissure.

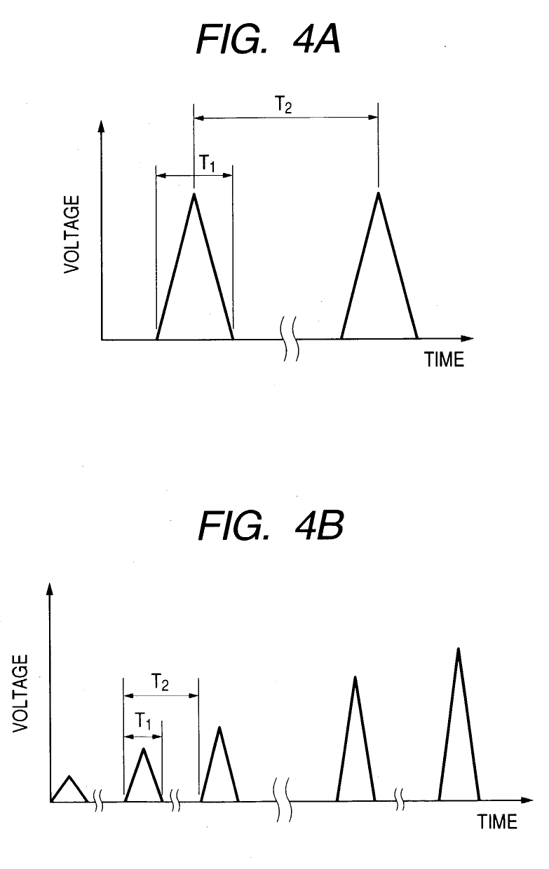

The process of the forming operation is executed by applying a voltage between the pair of the device electrodes 42 and 43. The voltage to be applied is preferably a pulse voltage. Either of the following two methods may be applied. One is to apply pulse voltages having the same peak value as shown in FIG. 4A. The other is to apply pulse voltages having gradually increasing peak values as shown in FIG. 4B. Incidentally, the pulse shapes of the pulse voltages are not limited to the triangular waveform shown in FIGS. 4A and 4B, but they may be other shapes such as a square waveform and the like.

After the electron-emitting region 45 is formed by the forming operation, a process called as an “activation process” is executed. The process is to deposit a material the principal component of which is carbon or a carbon compound at the electron-emitting region 45 and the periphery thereof by applying the pulse voltages repeatedly to the surface conduction electron-emitting device in an atmosphere including an organic material. Owing to the process, both of the electric current flowing between the device electrodes 42 and 43 (device current If) and the current accompanying electron emissions (emission current Te) increase.

The electron-emitting device produced through the forming operation process and the activation process is preferably processed by a stabilization process. The stabilization process is a process in which the organic material is exhausted from the vacuum container, especially from the neighborhood of the electron-emitting region 45. It is preferable to use a vacuum pumping apparatus using no oil as the vacuum pumping apparatus for exhausting the vacuum container lest the oil produced by the vacuum pumping apparatus should influence the characteristics of the electron-emitting device. To put it concretely, a vacuum pumping apparatus composed of a sorption pump and an ion pump, or the like can be cited.

The partial pressure of the organic material in the vacuum container is preferably the partial pressure at which the carbon or the carbon compound does not newly deposit to be 1.3×10⁻⁶ Pa or less. It is especially preferable to be 1.3×10⁻⁸ Pa or less. Moreover, when the inside of the vacuum container is exhausted, it is preferable to heat the whole of the vacuum container to make it easy to exhaust the molecules of the organic material absorbed on the inner wall of the vacuum container or absorbed to the electron-emitting devices. The heating condition at this time is to be within a temperature range from 80° C. to 250° C., preferably within a temperature of 150° C. or more. It is further preferable to execute the stabilization process as long as possible. However, the condition of the stabilization process is not limited to the above-mentioned conditions. The stabilization process is executed under conditions selected suitably according to the size and the shape of the vacuum container and to the configurations of the electron emitting devices. It is necessary to lower the pressure in the vacuum container as low as possible. It is preferable to be 1×10⁻⁵ Pa or less, in particular 1.3×10⁻⁶ Pa or less.

The vacuum atmosphere at the time of driving after the stabilization process preferably keeps the vacuum atmosphere at the time of the end of the stabilization process. However, the vacuum atmosphere is not limited to keep the end state. It is possible to maintain sufficiently stable characteristics as long as the organic material is sufficiently removed even if the degree of vacuum itself decreases a little. By the adoption of such a vacuum atmosphere, it is possible to suppress the deposition of new carbon or a new carbon component, and it is also possible to remove H₂O, O₂ and the like absorbed to the vacuum container or the substrate. As a result, the device current If and the emission current Ie are stabilized.

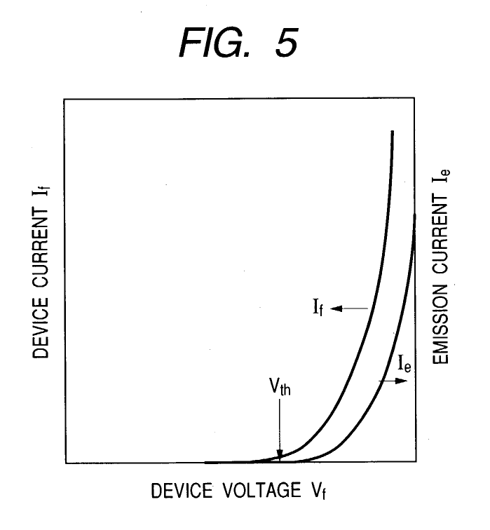

Relationships between the voltage Vf to be applied to the surface conduction electron-emitting device obtained in accordance with the way described above, and the device current If and the emission current Ie are typically shown in FIG. 5. Because the emission current Ie is remarkably small in comparison with the device current If, FIG. 5 shows them in arbitrary scale. Incidentally, both of the ordinate axis and the abscissa axis of FIG. 5 are linear scales.

In addition, as shown in FIG. 5, in the surface conduction electron-emitting device, when the device voltage Vf of a certain voltage (called as a threshold voltage: Vth in FIG. 5) or more is applied to the surface conduction electron-emitting device, the emission current Ie steeply increases. On the other hand, when the applied device voltage Vf is smaller than the threshold voltage Vth, the emission current Ie is hardly detected. That is, the surface conduction electron-emitting device is a non-linear device having a clear threshold voltage Vth to the emission current Ie. By the use of the non-linearity of the surface conduction electron-emitting device, it is possible to form an image by providing matrix wiring composed of a plurality of pieces of row-directional wiring and a plurality of pieces of column-directional wiring to a plurality of two-dimensionally arranged electron-emitting devices, and by emitting electrons selectively from desired devices by passive matrix drive to irradiate the emitted electrons to the image-forming member 12.

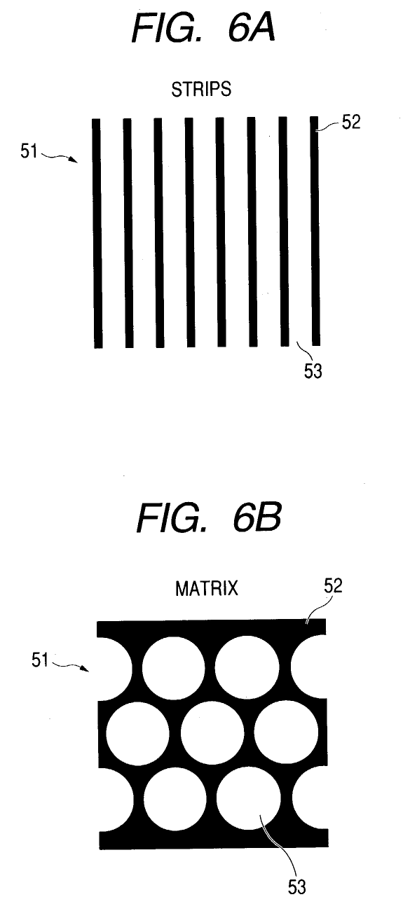

Next, examples of the configurations of the fluorescent films constituting the image-forming member 12 will be described. FIGS. 6A and 6B are type views showing the fluorescent films. The fluorescent films 51 can be composed only of a phosphor in case of the monochrome fluorescent film 51. The fluorescent films 51 can be composed of a black conductive material 52 called as a black stripe, a black matrix or the like according to the arrangements of phosphors 53, and the phosphors 53 of three colors of red (R), green (G) and blue (B) and the like in case of the color fluorescent film 51. The object of providing the black stripe or the black matrix is to make color mixture or the like inconspicuous by making dividing parts of coating between each phosphor 53 of three primary color phosphors necessary in case of color display to be black, and to suppress deterioration in the contrast of display owing to reflection of external light on the fluorescent films 51. Materials having electrical conductivity, small transmissivity and small reflectivity may be used as the material of the black stripe besides the material including graphite as its principal component, which is ordinarily used.

Moreover, a precipitation method, a printing method, and the like can be adopted regardless of the monochrome fluorescent film or the color fluorescent film as the method for coating the phosphors 53 on the face plate 11. A metal backing (not shown) is provided on the inner faces of the fluorescent films 51. The object of the provision of the metal backing is to raise the brightness of the image-forming apparatus by reflecting the light directed to the inner face side among the light emitted from the phosphors 53 to the side of the face plate 11 in the way of mirror reflection, and to make the fluorescent films 51 operate as electrodes to which an electron beam accelerating voltage is applied, and further to protect the phosphors 53 from the damage of the inner face side of the phosphors 53 owing to collisions of anions generated in the envelope of the image-forming apparatus. The metal backing can be manufactured by executing a smoothing process (ordinarily, called as “filming”) of the surface of the inner face side of a fluorescent film after the fluorescent film has been made, and then by depositing Al on the smoothed surface by means of the vacuum evaporation or the like. Incidentally, transparent electrodes may be provided on the outer faces of the fluorescent films 51 for raising the electrical conductivities of the fluorescent films 51.

Incidentally, in case of color display, it is necessary to make each color of phosphors correspond to electron-emitting devices, and consequently the sufficiently precise setting of the positions of them is indispensable.

By the present embodiment having the configuration described above, it becomes possible to raise the reliability of a thin flat panel electron beam image-forming apparatus. By applying scanning signals and picture signals to electron-emitting devices formed on the matrix wiring, and by applying a high voltage to the metal backing of the image-forming member 12, it is possible to provide a large-sized thin image display for displaying images.

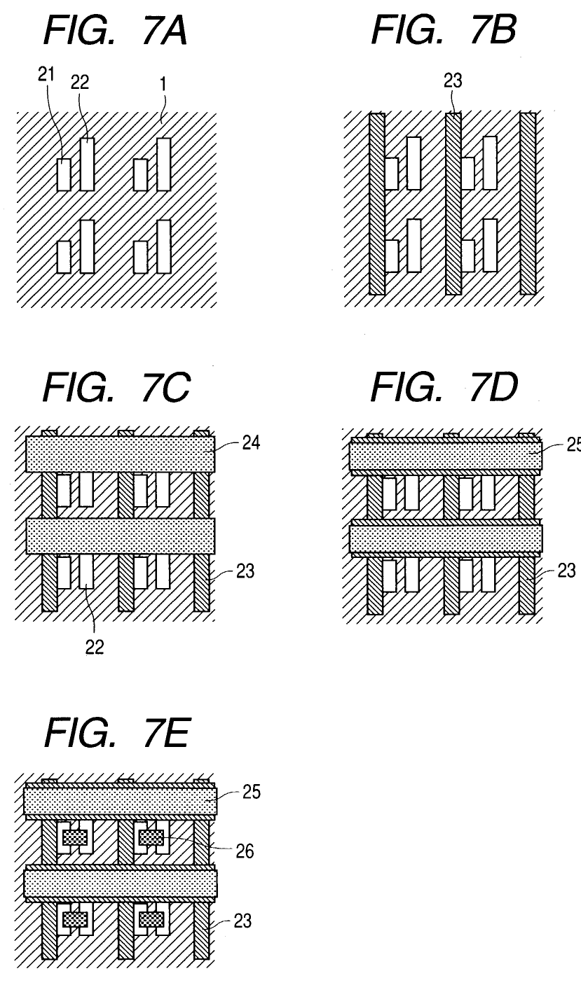

Next, a manufacturing method of an image-forming apparatus according to the present invention will further be described by means of FIGS. 7A-7E.

A plurality of surface conduction electron-emitting devices was formed on a rear plate used also as a substrate. Wiring was made in a matrix to form an electron source. By the use of the electron source, an image-forming apparatus was produced. In the following, the production procedure will be described in the order of each process by reference to FIGS. 7A-7E.

(Process a)

0.5 μm of SiO₂ layer was formed on a surface of a cleaned soda lime glass by sputtering to be the rear plate 1. Then, a circular passing hole having a diameter of 4 mm for introducing a ground connecting terminal was formed with an ultrasonic machine.

Device electrodes 21 and 22 of surface conduction electron-emitting devices were formed on the rear plate 1 by the use of a sputter deposition method and a photolithography method. The materials of the device electrodes 21 and 22 were laminated 5 nm of Ti and 100 nm of Ni. The intervals of the device electrodes 21 and 22 ware made to be 2 μm (FIG. 7A).

(Process b)

Next, Ag paste was printed to a prescribed shape to be calcined. Thus, Y-directional wiring 23 was formed. The Y-directional wiring 23 was elongated to the outside of an electron source formation area to be the wiring 3-2 for driving the electron source 2 in FIG. 1. The widths of the Y-directional wiring 23 were 100 μm, and the thicknesses thereof were 10 μm (FIG. 7B)

(Process c)

Next, insulating layers 24 were formed by the same printing method by the use of a paste including PbO as its principal component and a glass binder mixed to the PbO. The insulating layers 24 are for insulating the Y-directional wiring 23 from X-directional wiring, which will be described later. The insulating layers 24 were formed to be 20 μm in thickness. Incidentally, a notch was formed in a part of each of the device electrode 22 to connect the device electrodes 21 and 22 with the X-directional wiring (FIG. 7C).

(Process d)

Next, the X-directional wiring 25 is formed on the insulating layer 24 (FIG. 7D). The method of forming the X-directional wiring 25 is the same as that for the Y-directional wiring 23. The widths of the X-directional wiring 25 were 300 μm, and the thicknesses thereof ware 10 μm. After that, electroconductive films 26 composed of PbO fine particles were formed. The electroconductive films 26 were formed in accordance with the following method. That is, a Cr film was formed on the rear plate 1, on which the wiring 23 and 25 had been formed, by the sputtering method. Openings corresponding to the shapes of the electroconductive films 26 were formed in the Cr film. Successively, an organic Pd compound solution (ccp-4230 produced by Okuno chemical industries Co., Ltd.) was coated on the Cr film, and then the coated solution was calcined at 300° C. for 12 minutes in the atmosphere to form PdO fine particle films. After that, the Cr film was removed by wet etching to be the electroconductive films 26 having the predetermined shape by lift-off (FIG. 7E).

(Process e)

A paste including PbO as its principal component and glass binder mixed into PbO was further coated on the rear plate 1. Incidentally, the coating area of the paste was the area abutting in the inside of the supporting frame 4 in FIG. 1 except the area where the device electrodes 21 and 22, the X-directional wiring 25, the Y-directional wiring 23 and the electroconductive films 26 were formed (the area of the electron source 2 in FIG. 1).

(Process h)

Next, a face plate 11 was made. Similarly in case of the rear plate 1, soda lime glass provided with a SiO₂ layer was used as its substrate. An opening for the connection of an exhaust pipe and an anode wiring electrode entrance being a high voltage connection terminal were formed by ultrasonic machining. Then, a high voltage abutting part and a part for connecting the abutting part to a metal backing, which will be described later, were formed by Au printing. Furthermore, the black stripe of the fluorescent film was formed, and successively the phosphor in the shape of a stripe was formed. Then, the filming process of the phosphor was performed. After that, an Al film of about 20 μm in thickness was deposited on the phosphor by the vacuum evaporation method as the metal backing. Furthermore, Au paste was printed to surround the metal baking, and the Au paste was calcined to form a Au guard electrode 5. The width of the guard electrode 5 was 2 mm, and the thickness thereof was 100 μm. The distance of the guard electrode 5 from the metal backing was 4 mm. Next, graphite fine particles were coated by the spray coating method to form a high resistance film B14.

(Process i)

The supporting frame 4 joined to the rear plate 1 was joined to the face plate 1 with frit glass. The joining of a ground connecting terminal 15, an anode wiring electrode 18 and an exhaust pipe were executed at the same time. The ground connecting terminal 15 and the anode wiring electrode 18 were Ag bars. Incidentally, the positions of each electron-emitting device of the electron source 2 and the fluorescent film 51 of the face plate 11 were carefully set in order that they might accurately correspond to each other.

(Process j)

The image-forming apparatus was connected to the vacuum pumping apparatus with the exhaust pipe (not shown) to exhaust the container of the image-forming apparatus. When the pressure in the container was 10⁻⁴ Pa or less, the forming operation was executed.

The process of the forming operation was executed by applying pulse voltages having the peak values increasing gradually as typically shown in FIG. 4B to the X-directional wiring at every row in X direction. Pulse intervals T1 were set to be 10 sec. and pulse widths T2 were set to be 1 msec. Incidentally, a square wave pulse having a peak value of 0.1 V, though it was not shown in the figure, was inserted between two pulses for the forming operation to measure current values. The resistance values of the electron emitting devices were measured at the same time. When the resistance value per a device exceeded 1 MΩ, the forming operation of the row was finished, and the forming operation shifts to the next row. By repeating the forming operation in such a way, the forming operation to all of the rows was completed.

(Process k)

Next, the processing of the activation process was executed. Before the processing, the image-forming apparatus was kept at 200° C. while being exhausted with an ion pump, so that the pressure of the image-forming apparatus was decreased up to 10⁻⁵ Pa or less. Then, acetone was introduced into the vacuum container. The quantity of the acetone to be introduced was adjusted so that the pressure in the vacuum container was 1.3×10⁻² Pa. Successively, pulse voltages were applied to the X-directional wiring. The waveforms of the pulse voltages were square waves having the peak value of 16 V. The pulse widths of the pulse voltages were 100 μsec. The X-directional wiring, to which a pulse was applied at the interval of 125 μsec., was switched every pulse in serial order, and the application of the pulse to each wiring in row direction in serial order was repeated. As the result, the pulse was applied to each row at the interval of 10 msec. As the result of the processing, a deposited film containing carbon as its principal component was formed at the vicinity of the electron-emitting region of each electron-emitting device, and consequently the device current If became large.

(Process i)

Next, the vacuum container was again exhausted as the stabilization process. The exhaustion was executed for 10 hours by the use of the ion pump while keeping the image-forming apparatus at 200° C. The process is for eliminating organic materials remaining in the vacuum container to prevent the further deposition of the deposited film containing carbon as its principal component for stabilizing electron-emitting characteristics.

(Process m)

After returning the image-forming apparatus to a room temperature, pulse voltages were applied to the X-directional wiring by the method similar to that executed at the process k. Furthermore, when the voltage of 10 kV was applied to the image-forming member 12 through the anode wiring electrode 18, the fluorescent film emitted light. Incidentally, the ground connecting terminal 15 was connected to the ground at this time. It was ascertained whether there was a part from which light was not emitted or a part being very dark or not by observing the image-forming apparatus with human eyes. Then, the application of the voltages to the X-directional wiring and the image-forming member 12 was stopped. And, the exhaust pipe was heated to be welded. Then, image-forming apparatus was sealed. Successively, the getter processing was executed by high-frequency heating, and then the image-forming apparatus was completed.

The image-forming apparatus produced in the way described above realized low electrical power consumption while the apparatus could display a good image having high brightness and having no discharge.

(Second Embodiment)

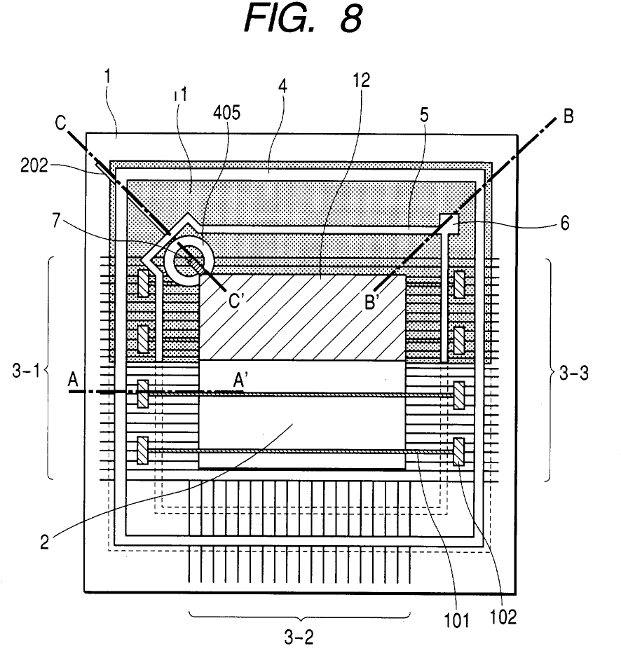

A second embodiment of the present invention will be described by the use of FIG. 8.

FIG. 8 is a plan view showing an example of the configuration of the image-forming apparatus of the present embodiment typically. FIG. 8 shows the configuration in case of being observed from upper side of its face plate.

Because the embodiment includes components used in the first embodiment shown in FIG. 1 in common, the configuration will be described only about parts different from those of the first embodiment in the following.

The points different from those of the first embodiment are that the anode wiring electrode 18 is located on the rear plate 1, and that the guard electrode 5 is also located on the rear plate 1 (hereinafter the guard electrode 5 on the rear plate 1 will be called as a rear plate side guard electrode), and further that there is no high resistance film B 14 on the face plate 11.

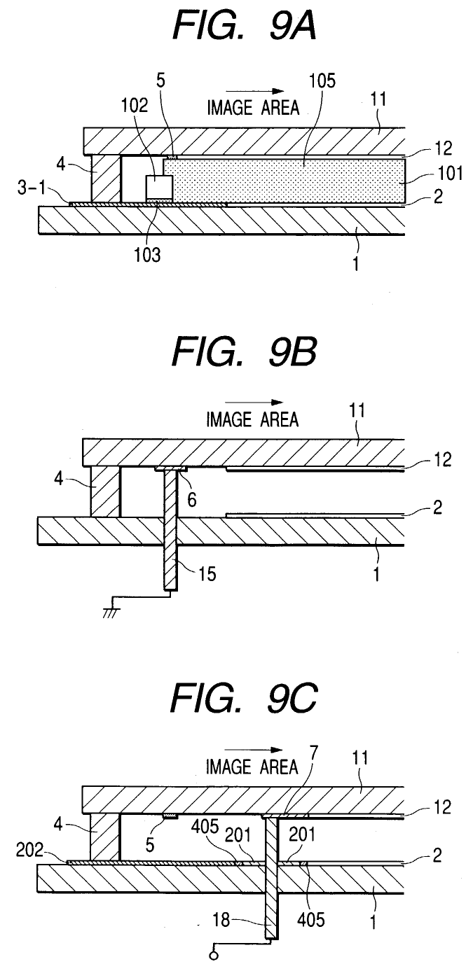

FIGS. 9A, 9B and 9C are type views showing the configurations of the cross sections along the A-A′ line, the B-B′ line and the C-C′ line in FIG. 8.

Although FIG. 9A is almost the same as FIG. 2A of the first embodiment, the high resistance film B 14 does not exist as described above, and the distance between the anode electrode 18 and the guard electrode 5 is long.

To put it concretely, the distance is set to be 20 mm, and thereby the electric field at this part is made to be sufficiently weak. Consequently, it is possible to realize a display in which no discharge is generated without any antistatic film.

The same antistatic high resistance films A 105 as those in the first embodiment are formed on the spacer 101.

In FIG. 9B, the ground connecting terminal 15 is connected to the abutting part 6 of the guard electrode 5. The ground connecting terminal 15 is a bar made of a metal such as Ag, Cu or the like. Incidentally, the configuration may be one to draw out the ground connecting terminal 15 onto the face plate side.

In FIG. 9C, the anode wiring electrode 18 is arranged on the rear plate side. A rear plate side guard electrode 405 made of a low resistance conductor surrounds the anode wiring electrode 18 in the state of a concentric circle having an inside diameter of 4 mm around the anode wiring electrode 18. The electric potential of the rear plate side guard electrode 405 is regulated to the ground potential with a drawn-out wiring 202. The anode wiring electrode 18 is a bar made of a metal such as Ag, Cu or the like. Moreover, a high resistance film B 201 is formed between the rear plate side guard electrode 405 and the anode wiring electrode 18. The high resistance film B 201 has the same object and the same configuration as those of the high resistance film B 14 of the first embodiment. That is, the sheet resistance value thereof is suitable to be within the range of 10¹⁰ Ω/□ to 10¹⁶ Ω/□, and was set at 10¹⁵ Ω/□ in this embodiment.

Similarly in the first embodiment, with regard to the sheet resistance values of these high resistance films, the following relationship was ascertained. That is, regarding the upper limit values of the sheet resistances for obtaining the same antistatic effect, it was ascertained that the relationship, (the upper limit values of the high resistance films A 105)<(the upper limit value of the high resistance film B 201), was always satisfied. The reason why the relationship was satisfied is the same as that in the first embodiment.

As described above, the wall surfaces of the spacer 101 and the area between the anode wiring electrode 18 and the rear plate side guard electrode 405 among the surfaces exposed on the inside of the display are covered with high resistance films for antistatic treatment.

In such a way, by covering the parts to which a high electric field is applied of the parts to which an electric field is applied among the internal surfaces of the vacuum container, in concrete terms, at least the surfaces to which electric fields of 2 kV/mm or more are applied, with the antistatic films, the generation of any discharge can be escaped. Incidentally, there is a part where no antistatic film is provided around the anode electrode. However, the intensity of the electric field at this part is less than 2 kV/mm. Moreover, although the spacers 101 having the tabular shape longer than the image area are used in the present embodiment, the spacers 101 are not limited to this shape. For example, the shapes may be tabular one having a length shorter than that of the image area, or the shapes may be columnar.

As described above, by omitting the high resistance film around the anode, further lower electrical power consumption of the display can be realized. In addition to this, by drawing out the high voltage terminal (the anode wiring electrode 18) from the rear plate side, the structure on the image display surface side (the display surface side of the face plate 11) can be made to be simple.

The image-forming apparatus manufactured in the manner described above can display a good image having high brightness and having no discharge.

(Third Embodiment)

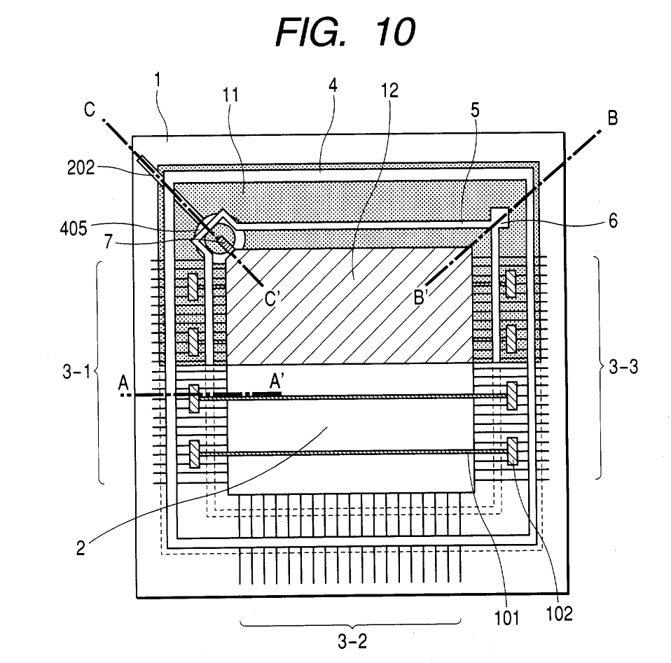

A third embodiment of the present invention will be described by reference to FIG. 10.

FIG. 10 is a plan view showing an example of the configuration of the image-forming apparatus of the present embodiment typically. FIG. 10 shows the configuration when it is observed from the upper side of its face plate. The configuration will be described only about parts different from those of the first embodiment in the following.

The point different from the configuration of the first embodiment is that the anode wiring electrode 18 is located on the rear plate 1.

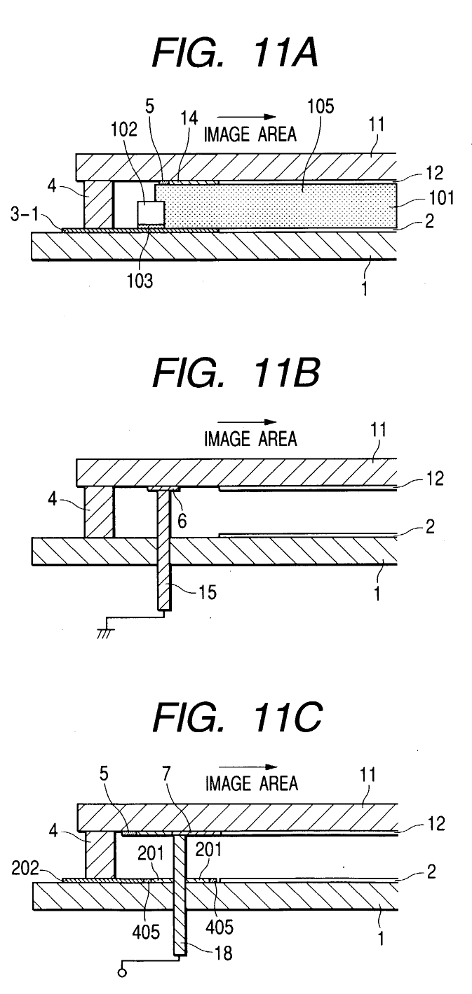

FIGS. 11A, 11B and 11C are type views showing the configurations of the cross sections along the A-A′ line, the B-B′ line and the C-C′ line in FIG. 10.

FIG. 11A is the same as FIG. 2A of the first embodiment. In FIG. 11A, the reference numeral 14 designates the high resistance film B on the face plate 11. The high resistance film B 14 is formed in the area between the guard electrode (low resistance conductor) 5 and the image-forming member 12 on the inner wall of the vacuum container. The reference numeral 101 designates the spacers, on which the same high resistance films A 105 as those of the first embodiment are formed.

In FIG. 11B, the ground connecting terminal 15 is connected to the abutting part 6 of the guard electrode 5. The ground connecting terminal 15 is a bar made of a metal such as Ag, Cu or the like. Incidentally, the configuration may be one to draw out the ground connecting terminal 15 onto the face plate side.

In FIG. 11C, the anode wiring electrode 18 is arranged on the rear plate side. The rear plate side guard electrode 405 made of a low resistance conductor surrounds the anode wiring electrode 18 in the state of a concentric circle having an inside diameter of 4 mm around the anode wiring electrode 18. The electric potential of the rear plate side guard electrode 405 is regulated to the ground potential with the drawn-out wiring 202. The anode wiring electrode 18 is a bar made of a metal such as Ag, Cu or the like. Moreover, the high resistance film B 201 is formed between the rear plate side guard electrode 405 and the anode wiring electrode 18 being the high voltage introducing terminal.

Although the suitable ranges of the sheet resistance values of the high resistance films A 105, and B 14 and 201 depend on the shape of the image-forming apparatus, the sheet resistances of the high resistance films A 105 are suitable to be within the range of 10⁷ Ω/□ to 10¹⁴ Ω/□. Moreover, the sheet resistances of the high resistance films B 14 and 201 are suitable to be within the range of 10¹⁰ Ω/□ to 10¹⁶ Ω/□. In the present embodiment, the sheet resistances of the high resistance films A (the first high resistance films) 105 were set at 10¹² Ω/□, and the sheet resistances of the high resistance films B (the second high resistance films) 14 and 201 were set at 10¹⁵ Ω/□.

As described in connection with the first and the second embodiments with regard to the sheet resistance values of these high resistance films, the following relationship has become clear experimentally. That is, regarding the upper limit value of the sheet resistances for obtaining the same antistatic effect, it was ascertained that the relationship, (the upper limit values of the high resistance films A 105)<(the upper limit values of the high resistance films B 14 and 201), was always satisfied. The reason why the relationship was satisfied is the same as that in the first embodiment.

As described above, the wall surfaces of the spacers 101, the area between the anode wiring electrode 18 and the rear plate side guard electrode 405, and the area between the guard electrode 5 and the anode electrode among the surfaces exposed onto the inside of the display are covered with high resistance films being antistatic films.

Incidentally, it is preferable to cover the parts where any electric field is applied, in particular the parts where the electric filed of 2 kV/mm or more is applied, with an antistatic film. The parts to be covered are ones other than the aforesaid parts covered with the antistatic film, in concrete terms, the insulating surfaces spaced from the anode electrode, which is composed of metal backing and the like and is a high voltage application part, without abutting the anode electrode, such as the insulating surfaces between the electron-emitting devices on the rear plate 1, the insulating surfaces neighboring electron-emitting devices between wiring, and the like. In particular, because there is the case where high electric fields are applied to the peripheries of the devices which generate electric fields at narrow gaps such as the surface conduction electron-emitting device, it is preferable to provide antistatic films thereto. Similarly, in the case where the anode electrode on the face plate 1 is patterned into, for example, a strip in the shape of a stripe so that insulating surfaces are exposed between the anode electrodes in the shape of the strips, and also in similar cases, it is preferable to cover the insulating surfaces with high resistance films for the object of the antistatic treatment. In these cases, according the position of the area where the antistatic film is formed is in the inside of the image-forming member formation area (the area where the image-forming member is formed and the orthogonal projection area of the former area onto the rear plate) or in the outside thereof, it may be enough to select the sheet resistance values of the antistatic films to satisfy the above-mentioned relationship, i.e. the relationship such that the sheet resistance value of the antistatic film on the inside of the image-forming member formation area is smaller than the sheet resistance value of the antistatic film on the outside of the image-forming member formation area. Moreover, in the present embodiment, the relationship between the sheet resistance values of the high resistance films A 105 and the sheet resistance values of the high resistance films B 14 and 201 at two positions was (the sheet resistance values of the high resistance films A 105)<(the sheet resistance values of the high resistance films B 14 and 201). However, if at least either of the sheet resistances of the two high resistance films B 14 and 201 satisfy the above relationship, the above-mentioned advantages can sufficiently be obtained. For example, if the sheet resistance value of the high resistance film B 14 satisfies the relationship, (the sheet resistance values of the high resistance films A 105)<(the sheet resistance value of the high resistance film B 14), the electrical power consumption can sufficiently be reduced even if the sheet resistance value of the high resistance film B 201 is equal to the sheet resistance value of the high resistance film A 105. Similarly, a part of the high resistance films A (the first high resistance films) 105 may be situated on the outside of the image-forming formation region. In short, if at least a part of the high resistance film situated on the outside of the image-forming member formation area has a higher sheet resistance value than that of the high resistance film situated on the inside of the image-forming area, the advantage of the present invention (to reconcile an antistatic effect and the decrease of electric power consumption) can be obtained. Furthermore, although the high resistance film B 14 and the high resistance film B 201 were made to be different films, both the films may be made of the same material.

Incidentally, although the tabular spacers having the length longer than the image area were used in the present embodiment like in the other embodiments, the spacers are not limited to the shape. The spacers may be tabular one having a length shorter than that of the image area, or may be columnar.

Furthermore, the present embodiment has the configuration in which all of the surfaces adjoining to the parts regulated by the high voltage (accelerating voltage) Va among the surfaces exposed to the vacuum of the display are covered by the antistatic films. Consequently, the present embodiment can suppress the electrical power consumption while preventing discharge and realizing the miniaturization of the display. That is, the relationship of largeness such that the sheet resistance values of the high resistance films A are made to be smaller than the sheet resistance values of the high resistance films B 14 and 201 is set, and thereby it becomes possible that the electric consumption power of the display apparatus is suppressed while the generation of discharge is suppressed. Incidentally, the high resistance films A exist in the image-forming member formation area, and are the antistatic films on the surfaces of the spacers, which surfaces are exposed in the vacuum. The high resistance films B are situated on the outside of the image area, and they are the antistatic films on the surfaces exposed into the vacuum. The films A and B are ones which abut on both of the electrode to which the high electric potential is applied and the electrode which is regulated by other electric potential such as the electric potential at the ground. The films A and B are also ones exposed into the vacuum.

The image-forming apparatus manufactured in the manner described above could realize the reduction of its electric power consumption and the miniaturization of its shape while making it possible to display a good image having high brightness and no discharge.

The application of the spirit of the present invention is not limited to the image-forming apparatus suitable for display, but the present invention can be applied to the image-forming apparatus using a light-emitting source as a substitution of the light-emitting diode of an optical printer composed of a photosensitive drum, a light-emitting diode and the like. In this case, by suitably selecting the above-mentioned row-directional wiring and the column-directional wiring, the present invention can be applied to a two-dimensional light-emitting source as well as a line light-emitting source. In this case, the image-forming member is not limited to the material which emits light directly such as a phosphor, but the member forming a latent image owing to the charge of electrons or the like can also be used. According to the sprit of the present invention, the present invention can be applied to the case where a member to be irradiated by electrons emitted from an electron source is one other than the image-forming member such as a phosphor like, for example, an electron microscope. Consequently, the present invention can take a form of a general electron beam apparatus which does not specify a member to be irradiated.

As described above, the image-forming apparatus according to the present invention consumes electric power very little. In the apparatus, no discharge is generated at the time of displaying an image. Moreover, the apparatus can obtain a good image with high brightness.

What is claimed is:

1. An image-forming apparatus comprising:
a rear plate provided with an electron source for emitting electrons; a face plate provided with an image-forming member having an anode electrode, to which electric potential higher than the highest potential to be applied to said electron source is applied, and a member for forming an image by being irradiated with electrons emitted from said electron source; and a vacuum container formed by arranging said rear plate and said face plate to be opposed to each other, said image-forming apparatus comprising:
a first high resistance film formed on at least a part of a first surface among surfaces exposed into said vacuum container, said first surface being situated on an inside of an area in which said image-forming member is formed; and
a second high resistance film formed at least a part of a second surface among said surfaces exposed into said vacuum container, said second surface being situated on an outside of the area in which said image-forming member is formed,
wherein at least a part of said second high resistance film has a sheet resistance value higher than that of said first high resistance film.

2. The image-forming apparatus according to claim 1, wherein a surface to which an electric field of at least 2 kV/mm or more is applied among said surfaces exposed into said vacuum container is covered with a high resistance film.

3. An image-forming apparatus comprising: a rear plate provided with an electron source for emitting electrons; a face plate provided with an imaging-forming member having an anode electrode, to which electric potential higher than the highest potential to be applied to said electron source is applied, and a member for forming an image by being irradiated with electrons emitted from said electron source; a vacuum container formed by arranging said rear plate and said face plate to be opposed to each other; a spacer abutting on said image-forming member and said electron source to hold a space between said face plate and said rear plate; an anode wiring electrode for feeding said anode electrode; and guard electrodes disposed around at least one of said anode electrode and said anode wiring electrode, said guard electrodes being regulated to electric potential lower than electric potential to be applied to said anode electrode, said spacer, said anode wiring electrode and said guard electrodes being placed in said vacuum container, said image-forming apparatus comprising:
a first high resistance film which is formed on a surface of said spacer and electrically connected to said anode electrode and said electron source; and
a second high resistance film which is formed on an inner face of said vacuum container between at least either one of said anode electrode and said anode wiring electrode and said guard electrodes and electrically connected to said at least either one of said anode electrode and said anode wiring electrode and said guard electrodes,
wherein at least a part of said second high resistance film has a sheet resistance value higher than that of said first high resistance film.

4. The image-forming apparatus according to claim 3, wherein said guard electrode is formed on an inner face of said face plate.

5. The image-forming apparatus according to claim 3, wherein said anode wiring electrode includes a part coming in contact with an inner face of said rear plate, and at least one of said guard electrodes is formed on the inner face of said rear plate.

6. The image-forming apparatus according to any one of claims 1, wherein said electron source includes a plurality of electron-emitting devices connected to wiring.

7. The image-forming apparatus according to claim 6, wherein said electron emitting devices are cold cathode devices.

8. The image-forming apparatus according to claim 7, wherein said cold cathode devices are surface conduction electron-emitting devices.
